(19) United States
(12) Patent Application Publication
(10) Pub. No.: US 2017/0048494 A1
(43) Pub. Date: Feb. 16, 2017

(54) UNDERWATER SURVEYS

(71) Applicant: CATHX RESEARCH LTD, Newhall (IE)

(72) Inventors: Adrian Boyle, Knavinstown (IE); Michael Flynn, Moatefield (IE)

(73) Assignee: CATHX RESEARCH LTD, Newhall (IE)

(21) Appl. No.: 15/306,373

(22) PCT Filed: Apr. 24, 2015
(86) PCT No.: PCT/EP2015/058985

§ 371 Date: Oct. 24, 2016

(30) Foreign Application Priority Data
Apr. 24, 2014 (GB) 1407267.2

(51) Int. Cl. H04N 7/18; H04N 5/235; G01C 11/02; H04N 5/225

(52) U.S. Cl. CPC H04N 7/181; H04N 5/2256; H04N 5/2258; H04N 5/2354; G01C 11/02

(57) ABSTRACT

Provided is a method of carrying out an underwater video survey of a scene, the method operating in an underwater imaging system comprising a first camera module, a second camera module and a lighting module to provide a plurality of illumination profiles, wherein the method comprises repeating the following steps at a desired frame rate: the first camera module capturing a first image of the scene, where the scene is illuminated according to a first illumination profile; and the second camera module capturing a second image of the scene, where the scene is illuminated according to a second illumination profile; characterised in that the first camera module is a HD colour camera module and the first illumination profile provides white light suitable for capturing a HD image; and the second camera module is a low light camera module, and the second illumination profile is suitable for use with the low light camera module.

### BACKGROUND

Underwater surveying and inspection is a significant component of many marine and oceanographic sciences and industries. Considerable costs are incurred in surveying and inspection of artificial structures such as ship hulls; oil and cable pipelines; and oil rigs including associated submerged platforms and risers. There is great demand to improve the efficiency and effectiveness and reduce the costs of these surveys. The growing development of deep sea oil drilling platforms and the necessity to inspect and maintain them is likely to push the demand for inspection services even further. Optical inspection, either by human observation or human analysis of video or photographic data, is required in order to provide the necessary resolution to determine their health and status.

Conventionally the majority of survey and inspection work would have been the preserve of divers but with the increasing demand to access hazardous environments and the continuing requirement by industry to reduce costs, the use of divers is becoming less common and their place being taken by unmanned underwater devices such as Remotely Operated Vehicles (ROV), Autonomous Underwater Vehicles (AUV) and underwater sentries.

ROVs and AUVs are multipurpose platforms and can provide a means to access more remote and hostile environments. They can remain in position for considerable periods while recording and measuring the characteristics of underwater scenes with higher accuracy and repeatability.

An underwater sentry is not mobile and may be fully autonomous or remotely operated. An autonomous sentry may have local power and data storage while a remote operated unit may have external power.

Both ROVs and AUVs are typically launched from a ship but while the ROV maintains constant contact with the launch vessel through an umbilical tether, the AUV is independent and may move entirely of its own accord through a pre-programmed route sequence.

The ROV tether houses data, control and power cables and can be piloted from its launch vessel to proceed to locations and commence surveying or inspection duties. The ROV relays video data to its operator through the tether to allow navigation of the ROV along a desired path or to a desired target.

ROVs may use low-light camera systems to navigate. A ‘low light’ camera may be understood to refer to a camera having a very high sensitivity to light, for example, an Electron-Multiplying CCD (EECCD) camera, a Silicon Intensifier Target (SIT) camera or the like. Such cameras are very sensitive and can capture useful images even with very low levels of available light. Low light cameras may also be useful in high-turbidity sub-sea environments, as the light levels used with a low light camera result in less backscatter. As the demands for video inspection by ROVs increased, camera systems requiring high light levels began to be installed on ROVs to capture high quality survey images. The light levels necessary to capture good quality standard definition or HD images may be incompatible with low-light cameras. ROVs may use multibeam sonar for navigation.

It is an object of the present invention to overcome at least some of the above-mentioned disadvantages.

### BRIEF SUMMARY OF THE DISCLOSURE

According to one aspect, there is provided a method of carrying out an underwater survey of a scene, the method operating in an underwater imaging system comprising a first camera module, a second camera module and a lighting module to provide a plurality of illumination profiles, wherein the method comprises: the first camera module capturing a first image of the scene, where the scene is illuminated according to a first illumination profile; and the second camera module capturing a second image of the scene, where the scene is illuminated according to a second illumination profile; characterised in that the second camera module is a low light camera module, and the second illumination profile is suitable for use with the low light camera module.

Optionally, the method is carried out a desired frame rate to provide a video survey.

Optionally, the first camera module is a High Definition (HD) colour camera module and the first illumination profile provides white light suitable for capturing a HD image.

Optionally, the first camera module is a standard definition camera module and the first illumination profile provides white light suitable for capturing a standard definition image. Such a camera may be a colour or monochrome camera.

Optionally, the first camera module is a monochrome camera module and the first illumination profile provides white light suitable for capturing an SD image.

Optionally, the lighting module is inactive for the second illumination profile.

Optionally, the lowlight camera module is fitted with a polarising filter and the second light profile comprises a polarised structured light source.

Optionally, the method comprises relaying the first image to a first output device and relaying the second image to a second output device

Optionally, the method comprises the additional steps of: carrying out image analysis on each of the first image and second image to extract first image data and second image data; providing an output image comprising the first image data and second image data.

According to a further aspect, there is provided a method of carrying out an underwater survey of a scene, the method operating in an underwater imaging system comprising a first camera module, a second camera module and a lighting module to provide a plurality of illumination profiles, wherein the method comprises: at a first time, the first camera module capturing a first image of the scene, where the scene is illuminated according to a first illumination profile; at a second time, the second camera module capturing a second image of the scene, where the scene is illuminated according to a second illumination profile; wherein the second time lags the first time by a period of predefined duration.

Optionally, the steps method is carried out a desired frame rate to provide a video survey.

Optionally, the method comprises comprising the additional step of: at a third time, the second camera module capturing a third image of the scene where the scene is illuminated according to a third illumination profile, the third illumination profile is derived from the second illumination profile. The third illumination profile may comprise a laser line identical to the laser line of the second illumination profile but in an adjusted location. There may be only small adjustments to the location of the laser line between image captures.

Optionally, the first illumination profile provides white light suitable for capturing a standard definition or high definition image and the second illumination and third illumination profiles comprise a laser line.

According to another aspect of the disclosure, there is provided a method of operating an underwater stationary sentry, the sentry comprising a camera module, a communication module, an image processing module and a lighting module to provide a plurality of illumination profiles, the steps of the method comprising: in response to a trigger event, capturing a set of images of the scene, each according to a different illumination profile, analysing the set of images to derive a data set relating to the scene, in response to a subsequent trigger event, capturing a further set of images of the scene according to the same illumination profiles as before; analysing the further set of images to derive a further data set relating to the scene;

comparing the data set to identify changes therebetween; transmitting the changes to a monitoring station.

### BRIEF DESCRIPTION OF THE DRAWINGS

Embodiments of the invention are further described hereinafter with reference to the accompanying drawings, in which:

FIG. 1 is a block diagram of an underwater survey system in which the present invention operates;

FIG. 2 is a block diagram of a sequential imaging module according to the invention;

FIG. 3 is a diagrammatic representation of an exemplary system for use with the method of the invention;

FIG. 4 is a timing diagram of an example method;

FIG. 5 is a further timing diagram of a further method; and

FIG. 6 is a flow chart illustrating the steps in an exemplary method according to the invention;

### DETAILED DESCRIPTION

### Overview

The present disclosure relates to systems and methods for use in carrying out underwater surveys, in particular those carried out by Remotely Operated Vehicles (ROVs), Autonomous Underwater Vehicles (AUVs) and fixed underwater sentries. The systems and methods are particularly useful for surveying manmade sub-sea structures used in the oil and gas industry, for example pipelines, flow lines, well-heads, and risers. The overall disclosure comprises a method for capturing high quality survey images, including additional information not present in standard images such as range and scale.

The systems and methods may further comprise techniques to manage and optimise the survey data obtained, and to present it to a user in an augmented manner.

The systems and methods may implement an integration of image capture, telemetry, data management and their combined display in augmented output images of the survey scene. An augmented output image is an image including data from at least two images captured of substantially the same scene using different illumination profiles. The augmented output image may include image data from both images, for example, edge date extracted from one image and overlaid on another image. The augmented output image may include non-image data from one or more of the images captured, for example the range from the camera to an object or point in the scene, or the dimensions of an object in the image. The additional information in an augmented output image may be displayed in the image, or may be linked to the image and available to the user to view on selection, for example dimensions may be available in this manner. The augmented output images may be viewed as a video stream or combined to form an overall view of the surveyed area. Furthermore, the systems and methods may provide an enhancement that allows structures, objects and features of interest within each scene to be highlighted and overlaid with relevant information. This may be further coupled with measurement and object identification methods.

For capturing the images, the disclosure provides systems and methods for capturing sequential images of substantially the same scene to form a single frame, wherein a plurality of images of the scene are captured, each illuminated using a different light profile. The light profiles may be provided by the lighting module on the vehicle or sentry and may include white light, UV light, coloured light, structured light for use in ranging and dimensioning, lights of different polarisations, lights in different positions relative to the camera, lights with different beam widths and so on. The light profiles may also include ambient light not generated by the lighting module, for example light available from the surface or light from external light sources such as those that may in place near a well-head or the like.

As mentioned above, images for a single frame may be captured in batches sequentially so that different images of the same field of view may be captured. These batch images may be combined to provide one augmented output image or frame. This technique may be referred to as sequential imaging. In some cases, the batches may be used to fine tune the parameters for the later images in the batch or in subsequent batches. Sequential illumination from red, green and blue semiconductor light sources which are strobed on and off and matched with the exposure time of the camera module so as to acquire three monochromatic images which can then be combined to produce a faithful colour image.

Measurement data is acquired and processed to generate accurate models or representations of the scene and the structures within it, and which is then integrated with the images of the same scene to provide an augmented inspection and survey environment for a user.

In particular, laser based range and triangulation techniques are coupled with the illumination and scene view capture techniques to generate quasi-CAD data that can be superimposed on the images to highlight dimensions and positioning of salient features of the scene under view.

Machine vision techniques play an important role in the overall system, allowing for image or feature enhancement; feature and object extraction, pattern matching and so on.

The disclosure also comprises systems and methods for gathering range and dimensional information in underwater surveys, which is incorporated into the method of sequential imaging outlined above. In the system, the lighting module may include at least one reference projection laser source which is adapted to generate a structured light beam, for example a laser line, a pair of laser lines, or a 2 dimensional array of points such as a grid. The dimensioning method may comprise capturing an image of the scene when illuminated by white light, which image will form the base for the augmented output image. The white light image may be referred to as a scene image. Next an image may be captured with the all other light sources of the lighting module turned off and the reference projection laser source turned on, such that it is projecting the desired structured light beam. This image shows the position of the reference beam within the field of view. Processing of the captured image in software using machine vision techniques provides range and scale information for the white light image which may be utilised to generate dimensional data for objects recorded in the field of view.

In one example, range to a scene may be estimated using a structured light source aligned parallel to the camera module and a fixed distance from the camera module. The structured light source may be adapted to project a single line beam, preferably a vertical beam if the structured light source is located to either side of the camera, onto the scene. An image is captured of the line beam, and that image may be analysed to detect the horizontal distance, in pixels, from the vertical centreline of the image to the laser line. This distance may then be compared with the known horizontal distance between the centre of the lens of the camera module and the structured light beam. Then, based on the known magnification of the image caused by the lens, the distance to the beam projected onto the beam may be calculated. Once the range is known, it is possible to derive dimensions for objects in the image, based on known pixel conversion tables for the range in question.

Additionally, the structured reference beam may provide information on the attitude of the survey vehicle relative to the seabed. Structured light in the form of one or more spots, lines or grids generated by a Diffractive Optical Element (DOE), Powell Lens, scanning galvanometer or the like may be used. Typically, green lasers are used as reference projection laser sources; however red/blue lasers may be used as well as or instead of green.

Furthermore, for a system comprising a dual camera and laser line, grid or structured light beams within a sequential imaging system, it is possible to perform metrology or inspection on a large area in 3D space in an uncontrolled environment, using 3D reconstruction and recalibration of lens focus, magnification and angle.

Capturing augmented survey images to provide a still or video output is one aspect of the disclosure. A further function of the system comprises combining images into a single composite image and subsequently allowing a user to navigate through them, identifying features, while minimising the data load required. Processing of the image and scale data can take place in real time and the live video stream may be overlaid with information regarding the range to the objects within the field of view and their dimensions. In particular the 3D data, object data and other metadata that is acquired can be made available to the viewer overlaid on, or linked to the survey stream. The systems and methods can identify features or objects of interest within the image stream based on a known library, as described in relation to processing survey data of an underwater scene. When a specific object has been identified, additional metadata may be made available such as a CAD data including dimensions, maintenance records, installation date, manufacturer and the like. The provision of CAD dimension data enables the outline of the component to be superimposed in the frame. Certain metadata may not be available to an AUV during the survey, but may be included at a later stage once the AUV has access to the relevant data libraries.

In addition, telemetry based metadata, such as location, may also be incorporated into the augmented output image.

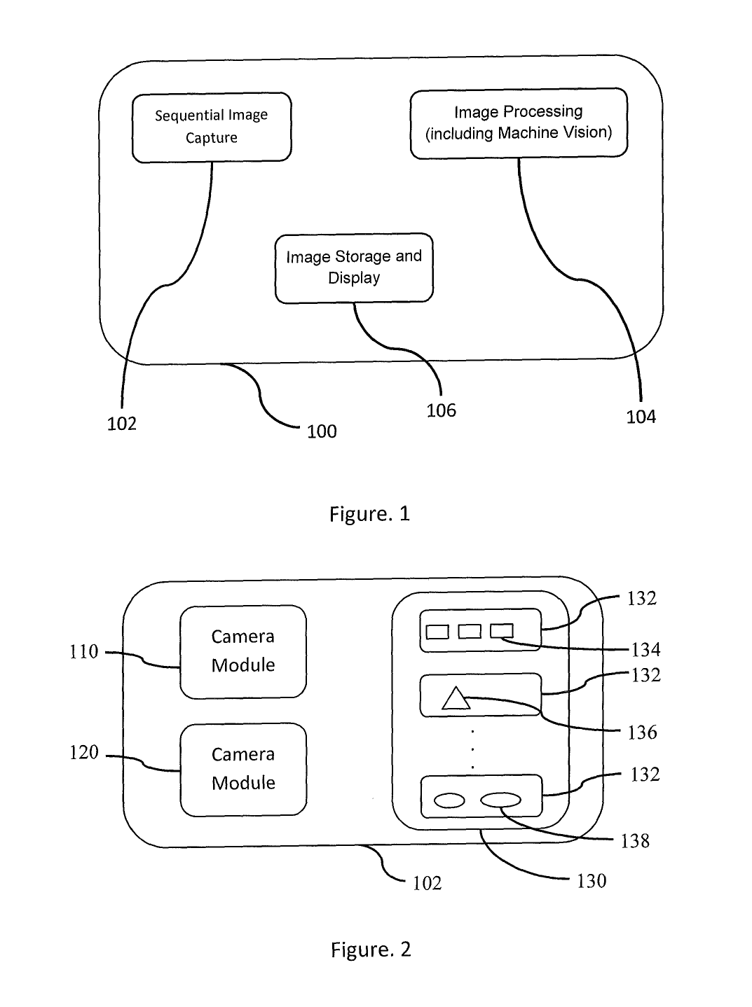

Referring to FIG. 1, there is shown a block diagram of the overall system 100 as described herein. The overall system 100 comprises a sequential imaging module 102, an image processing module 104 which includes a machine vision function, and an image storage and display module 106. In use, images are captured using sequential imaging, analysed and processed to from an augmented output image by the image processing module 104; and stored, managed and displayed by the image storage and display module 106.

### Terminology

There is provided a below a brief discussion on some of the terminology that will be used in this description.

Throughout the specification, the term field of view will refer to the area viewed or captured by a camera at a given instant.

Light profile refers to a set of characteristics of the light emitted by the lighting module, the characteristics including wavelength, polarisation, beam shape, coherency, power level, position of a light source relative to the camera, angle of beam relative to the camera orientation and so on and the like. A light profile may be provided by way of one of more light sources, wherein each light source belongs to a specific light class. For example, a white light illumination profile may be provided by four individual white light light sources, which belong to the white light class.

Exposure determines how long a system spends acquiring a single frame and its maximum value is constrained by the frame rate. In conventional imaging systems, this is usually fixed. Normally it is 1/frame rate for “full exposure” frames, so a frame rate of 50 frames per second would result in a full frame exposure of 20 ms. However, partial frame exposures are also possible in which case the exposure time may be shorter, while the frame rate is held constant.

Frame delay is the time between a clock event that signals a frame is to be acquired and the actual commencement of the acquisition. In conventional imaging systems this is generally not relevant.

A trigger event is may be defined by the internal clock of the camera system; may be generated by an external event; or may be generated in order to meet a specific requirement in terms of time between images.

The integration time of a detector is conventionally the time over which it measures the response to a stimulus to make an estimate of the magnitude of the stimulus. In the case of a camera it is normally the exposure time. However certain cameras have limited ability to reduce their exposure times to much less than several tens of microseconds. Light sources such as LEDs and lasers can be made to pulse with pulse widths of substantially less than a microsecond. In a situation where a camera with a minimum exposure time of 50 microseconds records a light pulse of 1 microsecond in duration, the effective integration time is only 1 microsecond and 98% shorter than the minimum exposure time that can be configured on the camera.

The light pulse width is the width of a pulse of light in seconds. The pulse of light may be longer than or shorter than the exposure.

The term light pulse delay refers to the delay time between the trigger event and the start of the light pulse.

The power of light within a given pulse is controlled by the control module and can be modulated between zero and the maximum power level possible. For an imaging system with well corrected optics, the power received by the sensor and the noise level of the sensor determine the image quality. Additionally, environmental factors such as scattering, absorption or reflection from an object, which can impair image acquisition, may require that the power is changed. Furthermore, within an image, parts of objects within a scene may reflect more light than others and power control over multiple frames may allow control of this reflection, thereby enabling the dynamic range of the sensor to be effectively increased. Potentially, superposition of multiple images through addition and subtraction of parts of each image can be used to allow this.

High dynamic range, contrast enhancement and tone mapping techniques can be used to compensate for subsea imaging challenges such as low visibility. High dynamic range images are created by superimposing multiple low dynamic range images, and can provide single augmented output images with details that are not evident in conventional subsea imaging.

The wavelength range of light visible to the human eye is between 400 nm blue and 700 nm red. Typically, camera systems operate in a similar range however, it is not intended that the system and methods disclosed herein be limited to human visible wavelengths only; as such the camera module may be generally used with wavelengths up to 900 nm in the near infra-red, while the range can be extended into the UV region of the spectrum with appropriate phosphors.

The term structured light beam may be understood to refer to beam having a defined shape, structure, arrangement, or configuration. It does not include light that provides generally wide illumination. Similarly, a ‘structured light source’ may be understood to refer to a light source adapted to generate such a beam. Typically, a structured light beam is derived from a laser, but may be derived in other ways.

### Sequential Imaging

Certain prior art sub-sea survey systems provide the user with a video output for review by an ROV pilot to allow him to navigate the vehicle. As such, the present system may be adapted to also provide a video output. Referring to FIG. 2, there is shown a block diagram of the sequential imaging module 102. The sequential imaging module may comprise a lighting module 130, a first camera module 110 and a second camera module 120. The lighting module 110 may comprise a plurality of light classes 132, each light class having one or more light sources 134, 136, 138. Various light profiles may be provided by activating certain light classes, or certain sources within a light class. A certain light profile may comprise no contribution from the light sources of the light module 130, such that imaging relies entirely on ambient light from other sources. The sequential imaging module may in general comprise light sources from three or four light classes, when intended for use in standard surveys. However, more light classes may be included if desired. An example sequential imaging module may be able to provide the following light profiles—white light, a blue laser line, UV light. The white light may be provided by light sources emitting white light or by coloured light sources combined to form white light. The power of the light sources may be variable. A UV light profile may be provided by one or more UV light sources.

Additional light profiles that could be provided include might include red, green, blue, green laser lines, a light source for emitting structured light which is offset from the angle of the camera sensor and so on.

The camera modules 110, 120 may be identical to each or may be different such that each is adapted for use with a particular light condition or profile.

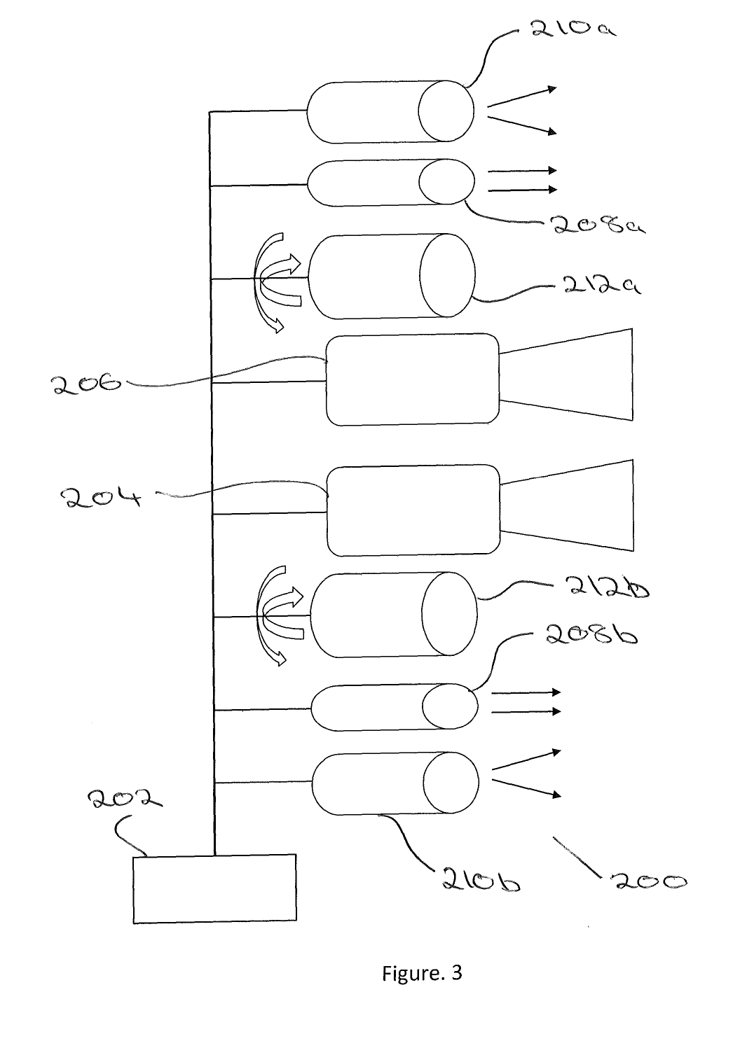

Referring now to FIG. 3, there is shown a diagrammatic representation of an example underwater imaging system, indicated generally by the reference numeral 200, for use with the methods disclosed herein. The system 200 comprises a control module 202 connected to a first camera module 204, a second camera module 206, and a plurality of light sources of different light classes. The light sources include a pair of narrow beam light sources 208a, 208b, a pair of wide beam light sources 210a, 210b and a pair of structured light light sources 212a, 212b. For example, narrow beam spot lights 208 may be useful if imaging from longer range, and wide beam lights 210 may be useful for more close range imaging. Structured light beams are useful for deriving range and scale information. The ability to switch between lights or groups of lights according to their output angle, and therefore the area of illumination, is highly beneficial as it can enhance edges and highlight shadowing. In this way, features that would not be visible if illuminated according to a prior art halogen lamp may now we captured in images and identified in subsequent processing.

The light sources may be aligned parallel to the camera modules, may be at an angle to the camera modules, or their angle with respect to the camera may be variable. The camera modules 204, 206 and light sources 208, 210, 212 are synchronized by the control module 202 so that each time an image is acquired, a specific configuration and potentially differing configuration of light source parameters and camera module parameters is used. Light source parameters are chosen to provide a desired illumination profile.

It will be understood by the person skilled in the art that a number of configurations of such a system are possible for subsea imaging and robotic vision systems, suitable for use with the system and methods described.

Each light source 208, 210, 212 can have their polarization modified either through using polarizers (not shown), or waveplates, Babinet-Soleil compensators, Fresnel Rhombs or Pockel's cells, singly or in combination with each other.

From an imaging perspective, in order to obtain efficient and good quality images the imaging cone of a camera module, as defined by the focal length of the lens, should match closely with the light cone illuminating the scene in question. Potentially the imaging system could be of a variable focus in which case this cone can be varied and could allow a single light source to deliver the wide and narrow angle beams.

The cameras may be high resolution CMOS, sCMOS, EMCCD or ICCD cameras with often in excess of 1 Mega pixels and typically 4 Mega pixels or more. In addition, cooled cameras or low light cameras may be used.

In general, the sequential imaging method comprises, for each frame, illuminating the scene according to a certain illumination profile and capturing an image under that illumination profile, and then repeating for the next illumination profile and so on until all images required for the augmented output image have been captured. The illumination profile may be triggered before or after the camera exposure begins, or the actions may be triggered simultaneously. By pulsing light during the camera exposure time, the effective exposure time may be reduced.

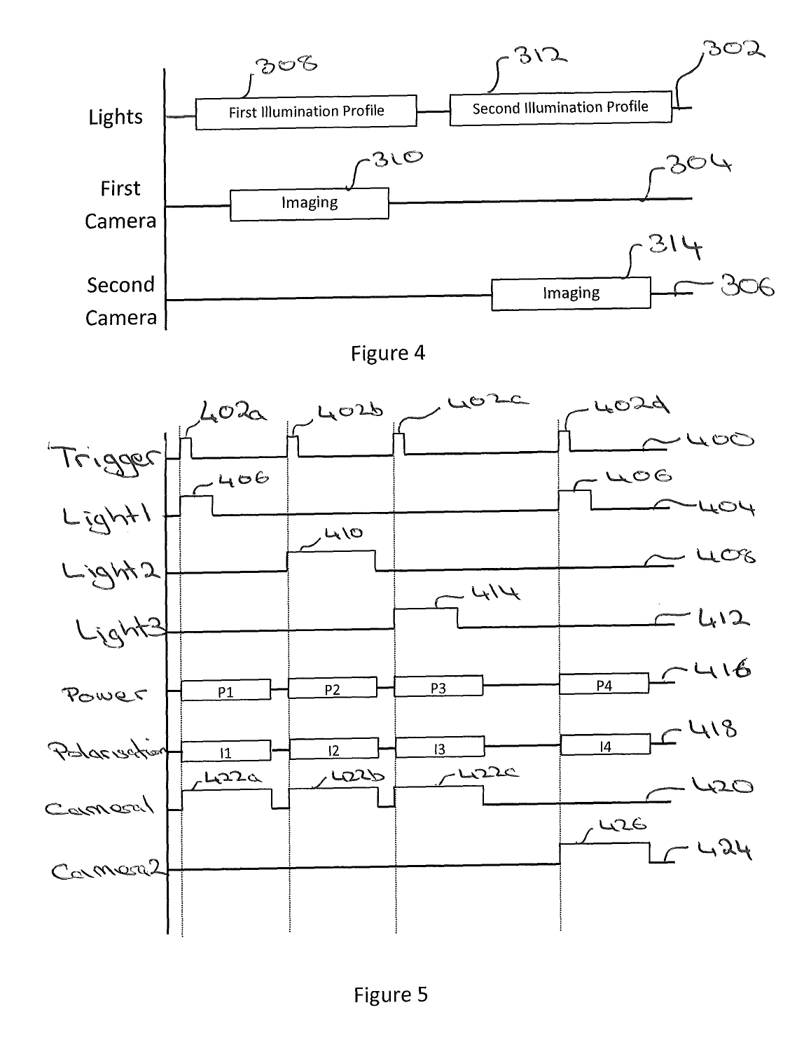

Referring now to FIG. 4 there is shown a basic timing diagram illustrating an example of the method disclosed herein. The diagram illustrates three timing signals 302, 304, 306, relating to the lighting module in general, the first camera module and the second camera module respectively. For a first period 308 in the lighting module timing signal 302, the lighting module implements the first illumination profile, and for a period 310, the first camera module 204 is capturing an image. The imaging time period 310 is illustrated shorter than the illumination period 308, however, in practice, it may be shorter than, longer than or equal in length to the illumination period. In a second period 312 in the lighting module timing signal 302, the lighting module implements the second illumination profile, and for period 314, the second camera module 206 is capturing an image. The imaging time period 314 is illustrated shorter than the illumination period 312, however, in practice, it may be shorter than, longer than or equal in length to the illumination period. In certain situations, one or more of the illumination periods 308, 312, may be considerably shorter than the imaging acquisition periods 310, 314, for example, if the illumination profile comprised the strobing of lights.

FIG. 5 shows a more detailed timing diagram illustrating a more detailed example of the method. In timing signal 400, there is shown a trigger signal 402 for triggering actions in the components. There are shown four trigger pulses 402a, 402b, 402c, 402d, the first three 402a, 402b, 402c being evenly spaced, and a large off-time before the fourth pulse 402b. In the next timing signal 404, there is shown the on-time 406 of a first light class, which is triggered by first trigger pulse 402a and the fourth trigger pulse 402d. In the third timing signal 408, there is shown the on-time 410 of a second light class, which is triggered by the second trigger pulse 402b. In timing signal 412, there is shown the on-time 414 of a third light class, which is triggered by the third trigger pulse 402c.

The power signal 416 relates to the power level used by that the lights sources, such that the first light sources uses power P1 in its first interval and power P4 in its second interval, the first light sources used P2 in its illustrated interval and the third light sources uses power P3 in its interval. The polarisation signal 418 relates to the polarisation profile used by that the lights sources, such that the first light sources uses polarisation I1 in its first interval and polarisation P4 in its second interval, the first light source uses polarisation I2 in its interval and the third light sources uses polarisation I3 in its interval. The power levels may be defined according to 256 levels of quantisation, for an 8 bit signal, adaptable to longer bit instructions if required. The first camera timing signal 420 shows the exposure times for the first camera, including three pulses 422a, 422b, 422c corresponding to each of the first three trigger pulses 402a, 402b, 402c. The second camera timing signal 424 comprises a single pulse 426 corresponding to the fourth trigger pulse 402d. Therefore, the first trigger pulse 402a causes the scene to be illuminated by the first light source (or sources) for a period 406, with a power level P1, a polarisation I1, and the exposure of the first camera module for a period 422a. The second trigger pulse 402b causes the scene to be illuminated by the second light source (or sources) for a period 410, with a power level P2, a polarisation I2, and causing the exposure of the first camera module for a period 422b. The third trigger pulse 402c causes the scene to be illuminated by the third light source (or sources) for a period 414, with a power level P3, a polarisation I3, and the exposure of the first camera module for a period 422c. The fourth trigger pulse 402d causes the scene to be illuminated by the first light source (or sources) for a period 406, with a power level P4, a polarisation I4, and the exposure of the second camera module for a period 426. The camera exposure periods 422a, 422b 422c are shown equal to each other but it will be understood that they may be different.

In this example illustrated in FIG. 5, the light sources could be any useful combination for example, red, blue and green, wide beam, narrow beam and angled, white light, UV light, laser light. In a situation of the red, blue and green, three exposures can then be combined in a processed superposition by the control system to produce a full colour RGB image 39 which through the choice of exposure times and power settings and knowledge of the aquatic environment allows colour distortions due to differing absorptions to be corrected.

The sequential imaging method is not limited to these examples, and combinations of these light sources and classes, and others, may be used to provide a number of illumination profiles. Furthermore, the sequential imaging method is not limited to three illumination profiles per frame.

It will be understood by the person skilled in the art that a delay may be implemented such that a device may not activate until a certain time after the trigger pulse.

The method may be used with discrete, multiple and spectrally distinct, monochromatic solid state lighting sources, which will involve the control of the modulation and slew rate of the individual lighting sources.

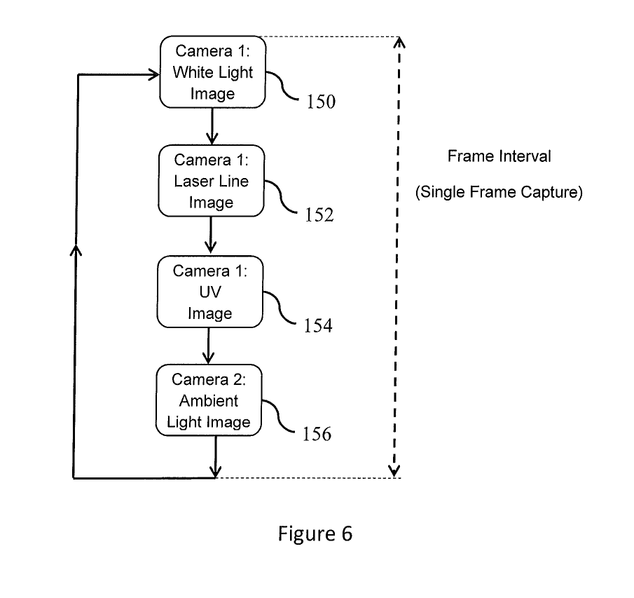

FIG. 6 is a flow chart of the operation of the exemplary sequential imaging module in carrying out a standard survey of an undersea scene, such as an oil or gas installation like a pipeline or a riser. The flow chart provides the steps that are taken in capturing a single frame, which will be output as an augmented output image. When in use on an ROV, the augmented output images are output as a video feed, however, for operation in an AUV the images are stored for later viewing. In step 150, an image of the scene is captured by the first camera module while illuminated by white light from the lighting module. Next in step 152 a structured light beam for example one or more laser lines, is projected onto projected onto the scene, in the absence of other illumination from the lighting module, and an image is captured by the first camera module of the scene including the structured light. Next, the scene is illuminated by UV light and an image is captured by the first camera module of the scene. Finally, the light module is left inactive, and a low-light image is captured by the second camera module. When the output of the sequential imaging process is intended to be combined and viewable as a standard video stream, each captured image is not displayed to the user. Therefore, the white light images form the basis for the video stream, with the laser line, UV and low light images being used to capture additional information which is used to enhance and augment the white light images. Alternatively the separate output can be viewed on separate displays. An ROV pilot would typically use the white light and low light stream on two displays to drive the vehicle. Other data streams such as structured light and UV may be monitored by another technician. In order to provide an acceptable video stream, a reasonably high frame rate must be achieved. A suitable frame rate is 24 frames per second, requiring that the steps 150, 152, 154 and 156 be repeated twenty four times each second. A frame rate of 24 frames per second corresponds to standard HD video. Higher standard video frame frames such as 25/30 Hz are also possible. When in use in an AUV, a lower frame rate may be implemented as it is not necessary to provide a video feed.

It is also possible to set the frame rate according to the speed of the survey vehicle, so as to ensure a suitable overlap between subsequent images is provided.

At a frame rate of 24 fps, the frame interval is 41.66667 ms. The survey vehicle moves quite slowly, generally between 0.5 m/s and 2 m/s. This will mean that the survey vehicle moves between approximately 20 mm and 80 mm in each frame interval. The images captured will therefore not be of exactly the same scene. However, there is sufficient overlap, around 90% and above, between frames that it is possible to align the images through image processing.

Each image captured for a single output frame will have an exposure time of a few milliseconds, with a few milliseconds between each image capture. Typical exposure times are between 3 ms and 10 ms., for example a white light image may have an exposure time of 3 ms, a laser line image might have an exposure time of 3 ms, and a UV image might have an exposure time of 10 ms, with approximately 1 ms between each exposure. It will be understood that the exposure times may vary depending on the camera sensor used and the underwater conditions. The lighting parameters may also be varied to allow shorter effective exposure times. It will be understood that the exposure time may be determined by a combination of the sensitivity of the camera, the light levels available, and the light pulse width. For more sensitive cameras such as a low light camera, the exposure time and/or light pulse with may be kept quite short, if there is plenty of light available. However, in an example, where it is desired to capture an image in low light conditions, the exposure time may be longer.

The sequential imaging module 102 is concerned with controlling the operational parameters of the lighting module and camera module such as frame rate, exposure, frame delay, trigger event, integration time, light pulse width, light pulse delay, power level, colour, gain and effective sensor size. The system provides for lighting and imaging parameters to be adjusted between individual image captures; and between sequences of image captures corresponding to a single frame of video. The strength of examples of the method can be best understood by considering the specific parameters that can be varied between frames and how these parameters benefit the recording of video data given particular application based examples.

Before image capture begins, the camera sensors are calibrated to any allow distortions such as pin cushion distortion and barrel distortion to be removed in real time. In this way, the captured images will provide a true representation of the objects in the scene. The corrections can be implemented in a number of ways, for example, by using a look up table or through sequential imaging using a calibrated laser source. Alternatively, the distortions may be removed by post-capture editing.

According to a further aspect of the invention, it is possible to use multiple light sources of differing colours in a system and to vary light control parameters individually or collectively between frames. By way of example, for underwater imaging, there is a strong dependence of light transmission on wavelength. As discussed, the absorption spectrum in water is such that light in the region around 450 nm has higher transmission than light in the red region of the spectrum at 630 nm. The impact of this absorption is significant when one considers the range of transmission of blue light compared to red light in sea water.

In an example of a blue light source and a red light source, having identical power and spatial characteristics, the initial power of the blue light will be attenuated to 5% of its value after propagating 324 m in the subaquatic environment, while the red light will be attenuated to 5% of its value after propagating only 10 m. This disparity in transmission is the reason why blue or green light are the dominant colours in underwater imaging where objects are at a range greater than 10 meters. Embodiments of the method of the invention can improve this situation by increasing the power level of the red light source, and so increasing its transmission distance. Thus, the use of colour control using multiple light sources according to embodiments of the method of the invention can greatly improve colour resolution in underwater imaging.

In addition to light power and colour or wavelength spread, the polarization of light has an impact on both the degree of scattering and the amount of reflected light. For imaging applications where backscatter from objects in front of the imaging sensor represent blooming centres, the ability to reduce the power level of backscattered light is critical. This becomes more so as the total power level of the light is reduced or where the sensitivity of the sensor system is increased. By changing or setting the polarisation state of a particular solid state light source or by choosing one polarized light source over another, this reflection and therefore camera dynamic range can be effectively improved. Scattering from particles in the line of sight between the camera and the scene under survey reduces the ability to the detection apparatus to resolve features of the scene as the scattered light which is often specularly reflected is of sufficiently high intensity to mask the scene. In order to reduce the scattered intensity polarization discrimination may be used to attenuate the scattered light and improve the image quality of the scene under survey.

Power modulation of the sources will typically be electrically or electronically driven. However it is also possible to modify the power emanating from a light source by utilizing some or all of the polarizers, waveplates, compensators and rhombs listed above and that in doing so potential distortions to the beam of the light sources arising from thermal gradients associated with electrical power modulation can be avoided.

In another aspect of the invention, shadow effects and edges in a scene are often highlighted by lighting power levels, lighting angle, lighting location with respect to the camera and/or lighting polarisation. Each of these can be used to increase the contrast in an image, and so facilitate edge detection. By controlling an array of lights of a number of different angles or directions, augmented edge detection capability can be realized.

Use of machine vision, combined with image acquisition under each illumination condition, allows closed loop control of lighting, camera parameters until a red signal is obtained. After the red signal is obtained, real time adjustment of the red channel power and camera sensitivity (exposure, gain, cooling) can be performed until the largest possible red signal is detected. Additional range data may also be obtained through a sequenced laser line generator which can validate, or allow adjustment of, the red channel parameters on the fly and in real time. Where no red channel is detected, alternative parameters for range enhancement may be used.

### Camera Parameters

According to further aspects of the invention, in addition to changing lighting parameters between individual frame acquisitions, the following parameters of the camera module can be changed between frame acquisitions: frame rate, frame synchronization, exposure time, image gain, and effective sensor size. In addition, sets of images can be acquired of a particular scene. The sets may include a set of final images, or a set of initial images that are then combined to make one or more final images. Digital image processing may be performed on any of the images to enhance or identify feature. The digital image processing may be performed by an image processing module, which may be located in the control module or externally.

The frame rate is the number of frames acquired in one second. The present invention, through adjustable camera control parameters, allows a variable frame rate; enables synchronization based on an external clock; and allows an external event to trigger a frame acquisition sequence.

Exposure time: The method of the invention allows for the acquisition of multiple images, not only under different illumination conditions but also under varying pre-programmed or dynamically controlled camera exposure times. For sensing specific defects or locations, the capability to lengthen the exposure time on, for example, the red channel of a multiple colour sequence, has the effect of increasing the amount of red light captured and therefore the range of colour imaging that includes red. Combined with an increase in red light output power, and coupled with the use of higher gain, the effective range for colour imaging can be augmented significantly.

Optimization of the gain on each colour channel provides an added layer of control to complement that of the exposure time. Like exposure time, amplifying the signal received for a particular image and providing the capability to detect specific objects in the image providing this signal, allows further optimization and noise reduction as a part of the closed loop control system.

Effective sensor size: Since the invention provides a means to acquire full colour images without the need for a dedicated colour sensor using sequential imaging with red illumination profile, blue illumination profile and green illumination profile, the available image resolution is maximized since colour sensors either require a Bayer filter, which necessarily results in pixel interpolation and hence loss of resolution, or else utilize three separate sensors within the same housing in a 3CCD configuration. Such a configuration will have a significantly higher power consumption and size than its monochrome counterpart.

The higher resolution available with monochrome sensors supports the potential use of frame cropping and binning of pixels since all of the available resolution may not be required for particular scenes and magnifications. Such activities can provide augmented opportunities for image processing efficiencies leading to reduced data transfer requirements and lower power consumption without any significant impairment to image fidelity.

Low light, cooled and specialist “navigation cameras” such as Silicon Intensifier Tubes (SIT) and vidicons or their equivalent CMOS, sCMOS, EMCCD, ICCD or CCD counterparts are all monochrome cameras and this invention and the control techniques and technologies described herein will allow these cameras to be used for full colour imaging through acquisition of multiple images separated by very short time intervals.

RGBU sensing: Adding an additional wavelength of light to the combination of red, green and blue described previously allows further analysis of ancillary effects. Specific defects may have certain colour patterns such as rust, which is red or brown; or oil, which is black on a non-black background. Using a specific colour of light to identify these sources of fouling adds significant sensing capability to the imaging system.

A further extension of this system is the detection of fluorescence from bio-fouled articles or from oil or other hydrocarbon particles in water. The low absorption in the near UV and blue region of the water absorption spectrum makes it practical to use blue lasers for fluorescence excitation. Subsequent emission or scattering spectra may be captured by a monochromator, recorded, and compared against reference spectra for the identification of known fouling agents or chemicals.

RGBRange Sensing: Using a range check, the distance to an object under survey can be accurately measured. This will enable the colour balancing of the RGB image and hence augmented detection of rust and other coloured components of a scene.

RGBU: A combination of white light and structural light, where structural light sources using Diffractive Optical Elements (DOEs) can generate grids of lines or spots provide a reference frame with which machine vision systems can make measurements. Such reference frames can be configured to allow ranging measurements to be made and to map the surface and height profiles of objects of interest within the scene being observed. The combination of rapid image acquisition and the control of the lighting and structured light reference grid, as facilitated by the invention, ensure that the data can be interpreted by the control system to provide dimensional information as an overlay on the images either in real time or when the recorded data is viewed later.

### Examples of Sequential Imaging with Two Camera Modules

The use of two camera modules in the sequential imaging module can provide a number of useful advantages.

In a first example, two cameras may be used to increase the effective frame rate of image acquisition. By synchronising the exposure times of the camera modules such that one lags the other by a suitable time period and by controlling the illumination profiles for each image acquisition, and subsequently combining the images, or features thereof, into a single output, it is possible to increase the effective frame rate of that output. For example, it may be desired to have a very high frame rate white light image, however it may also be desired to capture range information using a laser line image. With a single camera, it may not be possible to capture the white light image and laser line image at the requested high frame rate. In this situation, the first camera module may operate at the required high frame rate, with the sequential imaging system controlling the lighting module such that there is a white light illumination profile in effect for each image acquisition of the first camera module. Then, the second camera module may operate at the same frame rate, but in the off-time of the first camera module, to capture laser line images, where a structured light beam is projected onto the scene in question in a second illumination profile.

Furthermore, the camera modules do not have to operate at the same frame rate. The second camera module may acquire one image for every two, or three etc. images acquired by the first camera module. The rate of image acquisition by the second camera module may be variable and controlled according to data acquired.

In a second example of sequential imaging using two camera modules, the second camera module may comprise a ‘low light’ camera, that is a camera having a very high sensitivity to light, for example, an Electron-Multiplying CCD (EECCD) camera, a Silicon Intensifier Target (SIT) camera or the like. As such, low light cameras may be able to capture useful images when the light levels present are very low. Low light cameras typically have a sensitivity of between 10-3 and 10-6 lux. For example, the Bowtech Explorer Low light camera quotes a sensitivity of 2×10−5 while the Kongsberg 0E13-124 low light camera also quotes a sensitivity around 10-5 lux. Typically, a low light camera would not work with the lighting levels used to capture survey quality images using conventional photography or video, for example. The high light levels would cause the low light image sensor to saturate and create bloom in the image. This problem would be exacerbated if using a HD camera for surveying, as very high light levels are used for HD imaging. However, the sequential imaging method allows for control of the light profiles generated by the lighting module, therefore it is possible to reduce the light levels to a level suitable to imaging using the low light camera. As such, according to the method, a first camera module, for example a HD colour camera module may acquire a first image, according to a first illumination profile, which provides adequate light for the HD camera module. Next, the low light camera acquires a second image according to a second illumination profile. One illumination profile suitable for use with a low light camera may comprise certain lights of the lighting module emitting light at low power levels. This will reduce backscatter and allow the low light camera to obtain an image. This may be particularly relevant in water of high turbidity which suffers from high backscatter.

Another illumination profile suitable for use with a low light camera may comprise the lighting module being inactive and emitting minimal light during image acquisition by the second camera module. In such a case, the low light camera would acquire an image using the ambient light. Such ambient light may be natural light if close to the surface, or may be light from another source, for example from lights fixed in place separate to the survey unit. When using lighting from an external source, the camera modules will not be affected by backscatter and, it may therefore be possible to obtain longer range images.

Alternatively, the lighting profile for use with the low light camera may be a structured light beam. In one example, the structured light beam may be polarised and the low light camera may be fitted with a polarising filter. In this way, it is possible to discriminate between the reflected light from the object under examination and scattered light from the surrounding turbid water, thus providing increased contrast. This might include the use of a half or quarter wave plate on the laser to change between linear, circular and elliptical polarisations, as well as one or more cameras with polarisers mounted to reject light in a particular vector component.

The use of a combination of low light camera and structured light beam may allow for longer range imaging of the structured light beams, for example up to 50 to 60 m. This may be particularly useful for acquiring 3D data over long distances.

When implementing sequential imaging using two camera modules, there are a number of options available for image processing. A first option may comprise providing an additional output stream, for example, images from the first camera module are processed to extract data and form an augmented output image, while images from the second camera are displayed to a user. Additionally, the images from both camera modules may be analysed so as to extract data from both. The extracted data may then be combined into one or more augmented image output streams. An image from a low light camera may be analysed to deduce if a better quality image may be available using different lighting, with the aim of reducing noise.

If using a low light camera for navigation, it may be directed in front of the survey vehicle so as to identify a clear path for the survey vehicle to travel. In such cases, the lowlight images would be analysed to detect and identify objects in the path of the survey vehicle.

In a system using multiple camera modules, it may be possible to orient the camera modules such that each captures a different field of view. In this way, adjacent or contiguous fields of view be captured, or two separate field view, or Furthermore, in a case of more than one camera module being used, the field of view of one camera module may be different in size to the field of view of the other camera, allowing for example, higher resolution imaging of one part of a scene.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

### Sentry Operation

The method and system of sequential imaging as described herein, using one or more camera modules, may be used as part of surveys carried out by ROVs, AUV and underwater fixed sentries. Sentries using the sequential imaging system are similar to ROVs and AUVs in that they comprise one or more camera modules; a plurality of light sources controlled to provide a variety of illumination profiles; an image processing module; and a communication module. There are two main types of sentries, those that are connected to a monitoring station on the surface using an umbilical, which can provide power and communications; and those that do not have a permanent connection to the surface monitoring station. Sentries without a permanent connection operate on battery power and may periodically wirelessly transmit survey data to the surface. Transmitting large amounts of data underwater can be power consuming, which is not desirable when operating on battery power.

Sentries may operate according to the sequential imaging method disclosed herein, in that they may capture a series of images under different illumination profiles, analyse the images, extracting features and data, which may then be combined into an augmented output image. However, typically, video is not required by those reviewing survey data from sentries. Typically, a sentry may be positioned near a sub-sea component such as a wellhead, an abandoned well, subsea production assets and the like to capture regular images thereof. As the sentry is stationary, there survey is not a moving survey and the images will largely be of the same field of view each time. Much of the image may be background information and will not relevant to the survey results. The sentry may be programmed to capture an image of the scene to be surveyed at regular intervals, for example. The interval may be defined by the likelihood of a change. For example, an oil well head may have a standard inspection rate of once per minute. If it is believed that there is a low likelihood of an issue arising, the standard rate could be slowed down to once per hour, resulting in further power saving. There may be significant amounts of redundant data in each acquired image.

In response to a trigger event, the sentry may capture a set of images of the scene, each according to a different illumination profile. For example, the sentry may capture a white light image, a UV image, a laser line image for ranging, further structured light beams for use in 3D imaging, a red light image, a green light image and a blue light image, images lit with low power illumination, or lit from a certain angle. It may be useful to use alternate fixed lighting from a number of directions to highlight or to enhance a feature in an image. Switching between lights or groups of lights according to their output angle, and therefore the area of illumination, is highly beneficial as it can enhance edges and highlight shadowing.

The image processing module may analyse the set of images to derive a data set relating to the scene. The data set may include the captured images and other information, for example extracted objects, edges detected, dimensions of features within the images, presence of hydrocarbons, presence of biofouling, presence of rust and so on. Subsequently, the camera module may capture a further set of images of the scene according to the same illumination profiles as before; and analyse those captured images to derive a further data set relating to the scene as captured in those images. It is then possible to compare the current images and associated data to previous images and data and so identify changes that have occurred in the time between the images being captured. For example, detected edges may be analysed to ensure they are not deformed. Objects may be extracted from an image and compared to the same objected extracted from previous images.

In this way, the development of a rust patch may be tracked over time, for example. Information on the changes may then be transmitted to the monitoring station. In this way, only important information is transmitted, and power is not wasted in transmitting large amounts of redundant data.

Typically, the sentry will be triggered to capture images according to a pre-programmed schedule, however, it may also be possible to send an external trigger signal to the sentry to cause it to adjust or deviate from the schedule. The sentry may be triggered by other sensors for example by a sonar or noise event. Triggering actions may wake the sentry from a sleep mode where no imaging was taking place. Triggering actions may also cause the sentry to change or adapt an existing sequential imaging program.

In a further power-saving method of operation of a sentry, additional image acquisitions may be triggered based on the analysis of captured images. For example, for power saving reasons the sentry may operate so as to capture a UV image every tenth image. However, white light images captured in the meantime may be analysed to identify potential issues in need of further investigation. Such issues include bubbles that could indicated leaks; trails in the sand, pipe breaks, delamination or cracking of the pipe, rocks or foreign objects such as mines located near the pipe. For example, if a potential leak is identified from a white light image, a UV illuminated image may be triggered at that time so as to further characterise the issue in the white light image.

It may also be useful to perform object extraction on any object identified in the images captured by the sentry, and then transmit the extracted object, excluding irrelevant data. This further reduces the data to be transmitted. The extracted object may be accompanied by the relevant derived data for the captured images including the object's location within the frame. The extracted object can then be overlaid on a previous survey image, CAD file, sonar image of the site, library image or the like to provide context when being reviewed. In other situations, only edge data may be of interest

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of carrying out an underwater video survey of a scene, the method operating in an underwater imaging system comprising a first camera module, a second camera module and a lighting module to provide a plurality of illumination profiles, wherein the method comprises repeating the following steps at a desired frame rate:
the first camera module capturing a first image of the scene, where the scene is illuminated according to a first illumination profile; and
the second camera module capturing a second image of the scene, where the scene is illuminated according to a second illumination profile;
characterised in that
the first camera module is a HD colour camera module and the first illumination profile provides white light suitable for capturing a HD image; and
the second camera module is a low light camera module, and the second illumination profile is suitable for use with the low light camera module.

2. A method as claimed in claim 1, in which the lighting module is inactive for the second illumination profile.

3. A method as claimed in claim 1, in which the lowlight camera module is fitted with a polarising filter and the second light profile comprises a polarised structured light source.

4. A method as claimed in claim 1, comprising relaying the first image to a first output device and relaying the second image to a second output device.

5. A method as claimed in claim 1, comprising the additional steps of:
carrying out image analysis on each of the first image and second image to extract first image data and second image data;
providing an output image comprising the first image data and second image data.

6. A method of carrying out an underwater video survey of a scene, the method operating in an underwater imaging system comprising a first camera module, a second camera module and a lighting module to provide a plurality of illumination profiles, wherein the method comprises repeating the following steps at a desired frame rate:
at a first time, the first camera module capturing a first image of the scene, where the scene is illuminated according to a first illumination profile;
at a second time, the second camera module capturing a second image of the scene, where the scene is illuminated according to a second illumination profile;
wherein the second time lags the first time by a period of predefined duration.

7. A method as claimed in claim 6 comprising the additional step of:
at a third time, the second camera module capturing a third image of the scene where the scene is illuminated according to a third illumination profile, the third illumination profile is derived from the second illumination profile.

8. A method as claimed in claim 6, in which the first illumination profile provides white light suitable for capturing a HD image and the second illumination and third illumination profiles comprise a laser line.

9. A method of operating an underwater stationary sentry, the sentry comprising a camera module, a communication module, an image processing module and a lighting module to provide a plurality of illumination profiles, the steps of the method comprising:
in response to a trigger event, capturing a set of images of the scene, each according to a different illumination profile,
analysing the set of images to derive a data set relating to the scene,
in response to a subsequent trigger event, capturing a further set of images of the scene according to the same illumination profiles as before;
analysing the further set of images to derive a further data set relating to the scene;
comparing the data set to identify changes there between;
transmitting the changes to a monitoring station.
